(19) United States
(12) Patent Application Publication
(10) Pub. No.: US 2025/0327346 A1
(43) Pub. Date: Oct. 23, 2025

(54) DOOR HANDLE ARRANGEMENT

(71) Applicant: WITTE Automotive GmbH, Velbert (DE)

(72) Inventor: Zdenek SLOVAN, Plzen (CZ)

(21) Appl. No.: 19/186,734

(22) Filed: Apr. 23, 2025

(30) Foreign Application Priority Data
Apr. 23, 2024 (DE) 10 2024 203 799.0

(51) Int. Cl. E05B 85/10; E05B 85/16

(52) U.S. Cl. CPC E05B 85/107; E05B 85/16

(57) ABSTRACT

An outside door handle arrangement for a vehicle door may have at least one movable door handle and an adjusting mechanism for the controlled movement of the door handle. The adjusting mechanism may have at least one first lever arm and a coupling rod with at least one guide element and one stop element. The first lever arm cooperates with the guide element of the coupling rod to move the door handle from a non-use position into a use position. The first lever arm also cooperates with the stop element to move the door handle from the use position into the non-use position.

### FIELD

The invention relates to a door handle arrangement, in particular an outside door handle arrangement for a vehicle door, in particular a side door.

### BACKGROUND

Vehicle doors typically comprise an outer door handle which is mechanically or electrically coupled to a locking mechanism. For example, actuating the door handle moves the locking mechanism from a locked position into an unlocked position in order to allow the vehicle door to be opened. The vehicle door comprises, for example, a door handle of which an outer surface is positioned so as to be approximately flush with an outer surface of an outer vehicle door wall when the door handle is in a non-use position. By means of an adjusting mechanism, the door handle can be moved outward into a use position, such that it can be grasped by a user.

The object of the present invention is to provide an improved door handle arrangement which allows secure guidance for moving a handle element into a use position or back into a non-use position. A further object of the invention is to specify a vehicle door with an improved door handle arrangement.

According to the invention, the object is achieved by a door handle arrangement having the features of claim 1. With regard to the vehicle door, the object is achieved according to the invention by the features of claim 12.

### SUMMARY

A door handle arrangement according to the invention comprises at least one movable door handle and an adjusting mechanism for the controlled movement of the door handle, wherein the adjusting mechanism comprises at least one first lever arm and a coupling rod with at least one guide element and a stop element, wherein the first lever arm cooperates with the guide element of the coupling rod to move the door handle from a non-use position into a use position and cooperates with the stop element to move the door handle from the use position into the non-use position.

Because the coupling rod, via which at least two lever arms for extending or retracting a movable door handle can be or are coupled to one another, has at least one guide element and one stop element, wherein the guide element and the stop element are each assigned a different function (extension function and retraction function), both a positively controlled extension movement and a positively controlled retraction movement of the door handle can be achieved. In addition, a manual emergency actuation and emergency extension movement of the door handle can be ensured.

This coupling rod also enables a compact design with fewer parts for the adjusting mechanism as a simple lever arrangement, with reduced noise.

The guide element of the coupling rod can be designed as a guide

opening, in particular as a hole contour. The guide element, for example the guide opening or the hole contour, can be square, in particular trapezoidal, round, for example oval. The guide element can be designed as an elongated hole.

The stop element of the coupling rod can be designed as a stop edge or stop projection. The stop element can protrude from a surface of the coupling rod, for example perpendicularly.

The coupling rod can have the stop element at one rod end. In a region in front of the stop element (in longitudinal extension), the coupling rod can have the guide element.

The first lever arm can comprise at least one counter guide element. The counter guide element of the first lever arm can be designed as a guide pin or guide bolt. The counter guide element can protrude from a surface of the first lever arm, for example perpendicularly.

The counter guide element can be guided in or on the guide element of the coupling rod.

The first lever arm may further comprise at least one counter stop element. The counter stop element can come into contact with the stop element of the coupling rod in order to return the door handle from the use position to the non-use position.

The first lever arm can be motor-driven to return the door handle from the use position to the non-use position. For example, in bad weather conditions that may cause the movement to jam due to snow and/or ice, partial or complete resetting can be ensured by the motor-driven first lever arm. Furthermore, for example, in normal operation an initial reset can be triggered by the motor operation of the first lever arm. The second lever arm is reset by a spring force. The spring force can be introduced by a tension spring or compression spring acting on the coupling rod. Additionally or optionally, a further spring element can be coupled to the second lever arm. The additional spring element can be a leg spring. If the movement is jammed by snow and/or ice, the spring force may not be sufficient to reset it. In this case, controlling/resetting this movement can be achieved through the interaction of the counter stop element of the first lever arm on the stop element of the coupling rod.

The counter stop element of the first lever arm is moved against the stop element of the coupling rod. A compressive force is exerted on the stop element of the coupling rod.

The counter guide element of the first lever arm can remain “inactive” in or on the guide element of the coupling rod. The reset movement of the coupling rod is effected solely by the operative connection of the counter stop element of the first lever arm with the stop element of the coupling rod until the adjusting mechanism reaches the non-use position.

The counter stop element of the first lever arm can be a counter stop lug or a counter stop face. The first lever arm may have the counter stop element at one lever end. The first lever arm can have the counter guide element in a region in front of the counter stop element (in longitudinal extension).

In the non-use position of the door handle or the adjusting mechanism, the counter guide element of the first lever arm can be positioned in a front region of the guide element of the coupling rod.

Because, in the non-use position the counter guide element, for example a guide pin, of the first lever arm in a front region of the guide element, for example a hole contour, of the coupling rod, an emergency extension path can be ensured, wherein, in the case of, for example, a manual emergency extension of the door handle, the second lever arm and the coupling rod can be pulled by a specifiable or specified distance. The distance is determined by the hole contour.

In the non-use position, the counter stop element of the first lever arm can be positioned pivoted away relative to the stop element of the coupling rod. In the non-use position, the counter stop element of the first lever arm has no contact with the stop element of the coupling rod.

In the use position of the door handle or the adjusting mechanism, the counter guide element of the first lever arm can be in contact with the front region of the guide element of the coupling rod. During normal operation, the counter guide element of the first lever arm can move the coupling rod in the guide element of the coupling rod, which is designed as a hole contour, so that a second lever arm is also extended. In the use position, the counter stop element of the first lever arm can be pivoted towards the stop element of the coupling rod and positioned in front of it.

By driving the first lever arm, the counter stop element of the first lever arm can come into direct contact with the stop element of the coupling rod and the coupling rod can be moved by applying force to the stop element of the coupling rod.

In normal operation, a movement of the first lever arm causes a movement of the coupling rod, to extend or retract a second lever arm coupled to the coupling rod. The guide pin arranged in the guide opening of the coupling rod can drive a movement of the coupling rod during normal operation.

A reset of the first lever arm causes a movement of the coupling rod and thus a reset of a second lever arm.

In emergency operation, for example in the event of an electronics and/or motor failure, the door handle can be manually moved from the non-use position in the region of the second lever arm. In emergency operation, the second lever arm and the coupling rod can initially be moved manually independently of the first lever arm until an emergency intermediate position is reached.

The door handle can initially be moved into or placed into an inclined position. For example, the door handle may be pivoted at a longitudinal first end in the direction of the vehicle door, wherein a longitudinal second end may be pivoted relatively away in the direction of the vehicle door.

In emergency operation, the counter guide element of the first lever arm in the guide element of the coupling rod can perform a contact-free movement. In other words, the coupling rod can be moved relative to the first lever arm by moving the second lever arm. The movement of the coupling rod is made possible by the fact that the hole contour of the coupling rod can be moved contact-free up to the guide pin of the first lever arm.

In the emergency intermediate position, the counter guide element of the first lever arm can be positioned in a rear region of the guide element of the coupling rod.

In the emergency intermediate position, the counter stop element of the first lever arm can come into contact with the stop element of the coupling rod. The counter stop element of the first lever arm can press on an upper side of the stop element of the coupling rod in order to move the coupling rod downwards. In other words: the counter stop lug of the first lever arm can come into contact with an upper side of the stop edge of the coupling rod in the emergency intermediate position.

From the emergency intermediate position, further movement of the coupling rod can cause the first lever arm to extend. In other words: In emergency operation, an initial movement of the second lever arm causes a positively controlled movement of the first lever arm via the coupling rod. The counter stop element of the first lever arm can press the coupling rod downwards at its stop element and swing past it until the use position is reached. This means that a relatively light impact and light emergency actuation stroke are sufficient for the emergency extension of the door handle into an emergency actuation position. An emergency position corresponds in this case to the normal use position of the door handle. In this emergency position and/or use position, a door lock and/or a door latch can be actuated.

In a further development, the coupling rod is preloaded by a spring element. The spring element can form a return spring. The spring element can be a compression spring. The spring element is arranged, in particular aligned, obliquely or largely perpendicularly to a longitudinal extension direction of the coupling rod and/or an X-axis. In particular, a preload force is aligned obliquely or largely perpendicularly to a longitudinal extension of the coupling rod. The coupling rod is pulled by the spring element in a first direction, for example in the extension direction of the door handle. This prevents the coupling rod from being pulled downwards/in the retraction direction when the door handle is in the use position, so that the stop element of the coupling rod and the counter stop element of the first lever arm remain out of contact.

The door handle arrangement can comprise at least one carrier element, an extendable door handle which is arranged on the carrier element so as to be movable between a retracted non-use position and an extended use position, and an adjusting mechanism for adjusting the door handle relative to the carrier element, wherein the adjusting mechanism comprises at least one first lever arm and a coupling rod with a guide element designed as a hole contour and a stop element designed as a support edge for the controlled movement of the door handle, wherein the hole contour cooperates with a guide element arranged on the first lever arm, in particular a counter guide element, for moving the door handle from the non-use position into the use position, and the support edge cooperates with a contact element arranged on the first lever arm, in particular a counter stop element, for moving the door handle from the use position into the non-use position.

The advantages achieved with the invention are in particular that the adjusting mechanism can be designed to be simple, compact and with reduced parts. Because the first lever arm has a counter guide element and a contact element, for example a counter stop element, for example in the form of a protruding lug or extension, and the coupling rod has a corresponding hole contour and a support edge, it is possible to dispense with multi-part lever mechanisms, driver mechanisms and coupling elements, for example cam carriers, for the controlled movement of the door handle.

The first lever arm can be driven by a drive unit, for example a motor. When the first lever arm extends, the coupling rod can be moved, in particular pressed, in a first direction in order to move, in particular to adjust, the door handle relative to the carrier element. For example, the adjusting mechanism may comprise a second lever arm coupled to the door handle, which is operatively connected to the coupling rod, wherein a movement of the coupling rod triggered by the first lever arm causes a movement of the second lever arm and thus a movement of the door handle.

The movement of the first lever arm leads to the positively controlled movement of the second lever arm. The reverse is not true. The second lever arm can extend without entraining the first lever arm. The second lever arm is moved outwards manually, for example in the case of an emergency actuation, also called emergency operation. The hole contour or the guide element in the coupling rod is designed and/or dimensioned in such a way that a movement of the coupling rod triggered by the second lever arm can take place, at least initially, largely without contact with the counter guide element on the first lever arm. This makes it possible to create an emergency extension function.

Furthermore, the invention relates to a vehicle door having at least one door handle arrangement as previously described. A vehicle door is equipped with at least one door handle arrangement as described above. In particular, the door handle arrangement is designed as an outside door handle arrangement. The door handle arrangement has a compact—in particular, compact in the Y- and Z-directions—low-wear, and cost-effective structure.

### DESCRIPTION OF THE FIGURES

Exemplary embodiments of the invention are explained in greater detail with reference to the drawings, in which:

FIG. 1 is a schematic perspective view of a vehicle door having a door handle arrangement with a handle element in a non-use position,

FIG. 2 is a schematic perspective view of a vehicle door having a door handle arrangement with a handle element in a use position,

FIG. 3 is a schematic perspective view of a vehicle door having a door handle arrangement with a handle element in an actuated end position,

FIG. 4 is a schematic rear view of an embodiment of a door handle arrangement with a carrier element, a door handle and an adjusting mechanism,

FIG. 5 is a schematic rear view of a further embodiment of a door handle arrangement with a carrier element, a door handle and an adjusting mechanism,

FIG. 6 is a schematic plan view of a door handle arrangement with a carrier element, a door handle partially moved from a non-use position, and an adjusting mechanism,

FIG. 7 is a schematic plan view of a door handle arrangement with a door handle in a use position,

FIG. 8 is a schematic plan view of a door handle arrangement with a door handle in a use position,

FIG. 9 is a schematic detail of a door handle arrangement with an adjusting mechanism in an initial position,

FIG. 10 is a schematic detail of a door handle arrangement with an adjusting mechanism in an extended position,

FIG. 11 is a schematic detail of a door handle arrangement with an adjusting mechanism in a first emergency extension position,

FIG. 12 is a schematic detail of a door handle arrangement with an adjusting mechanism in a second emergency extension position (emergency intermediate position),

FIG. 13 is a schematic detail of a door handle arrangement with an adjusting mechanism in a third emergency extension position (emergency intermediate position),

FIG. 14 is a schematic detail of a door handle arrangement with an adjusting mechanism in a fourth emergency extension position, which corresponds to a normal extended position, and

FIG. 15 is a schematic perspective view of a door handle arrangement.

### DETAILED DESCRIPTION

Parts corresponding to one another are provided with the same reference signs in all the drawings.

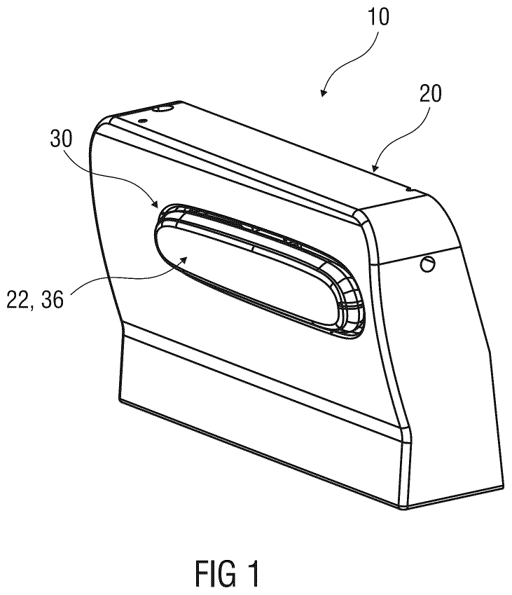

FIG. 1 is a schematic perspective view of a vehicle door 10 with a door handle arrangement 20, in particular an outside door handle arrangement, with a door handle 22, for example a handle element, in a non-use position 30. The non-use position 30 corresponds to a retracted position, for example a rest position or initial position 36, of the door handle 22.

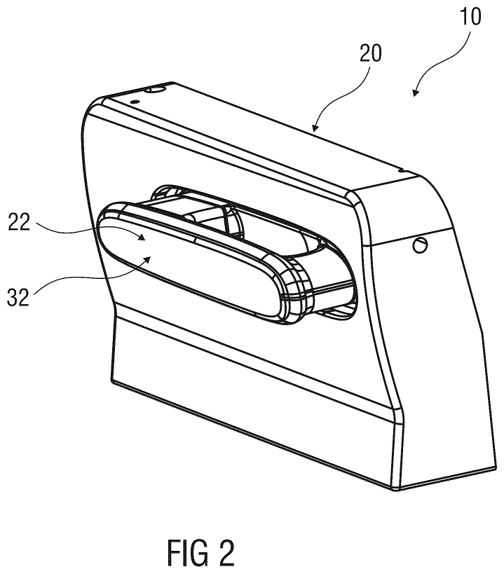

FIG. 2 is a schematic perspective view of a vehicle door 10 having a door handle arrangement 20 with a door handle 22 in a use position 32. The use position 32 corresponds to an extended position, for example the operating position, of the door handle 22.

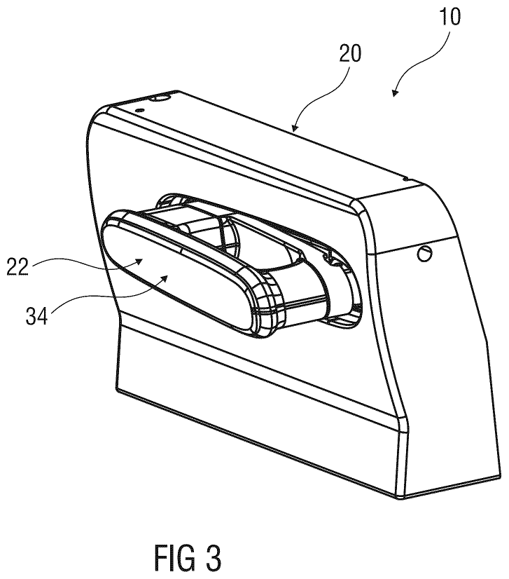

FIG. 3 is a schematic perspective view of a vehicle door 10 having a door handle arrangement 20 with a door handle 22 in an actuated end position 34, for example, pulled by a user. The end position 34, for example, corresponds to an end stop position.

In the non-use position 30, the door handle 22 is arranged flush with the vehicle door 10, in particular the vehicle body shell of the vehicle door 10. In the use position 32, the door handle 22 is lifted from the vehicle body shell and can be grasped and actuated, for example by pulling, for example to unlock an electronic door lock and/or to open the vehicle door 10. The door handle 22 is designed as a handleset. In the use position 32, the door handle 22 can be actuated by means of a pulling movement or a tipping movement. This movement of the door handle 22 can be transmitted to an electronic door lock so that the door lock and thus the associated vehicle door 10 open.

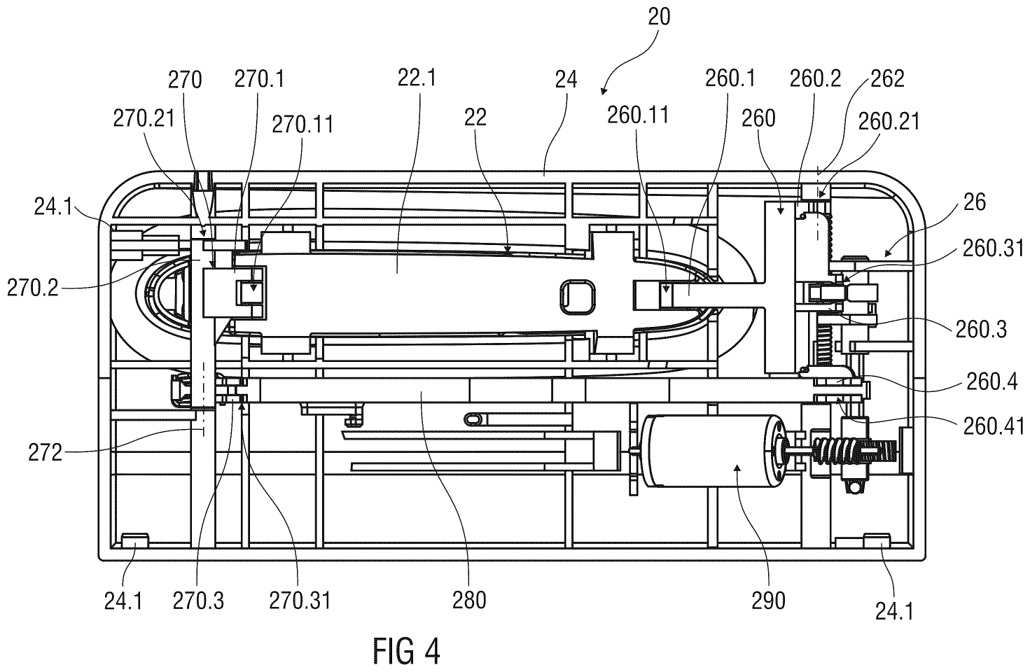

FIG. 4 is a schematic rear view of an embodiment of a door handle arrangement 20 with a carrier element 24, a door handle 22 and an adjusting mechanism 26.

The adjusting mechanism 26 comprises a first lever arm 260 which is mounted so as to be pivoted about a first axle 262. The adjusting mechanism 26 comprises a second lever arm 270 which is mounted so as to be pivoted about a second axle 272. Furthermore, the adjusting mechanism 26 comprises at least one coupling rod 280, which is coupled at each end to one of the lever arms 260, 270.

The adjusting mechanism 26 further comprises a drive unit 290 which drives the first lever arm 260 during operation and pivots it about the first axle 262, wherein the second lever arm 270 is entrained to pivot as well, due to its coupling with the coupling rod 280, when the first lever arm 260 is driven.

The first lever arm 260 is, for example, a first extending lever or a drive lever. The second lever arm 270 may be a second extending lever. The second lever arm 270 can be an extending lever designed as a toggle lever. The coupling rod 280 can be a simple lever.

The first lever arm 260 comprises at least one first lever arm portion 260.1, which is articulated via a first articulation point 260.11 on the door handle 22, for example on a first handle arm of the door handle 22. The first lever arm 260 comprises at least one second lever arm portion 260.2, which is articulated on the carrier element 24 via a second articulation point 260.21. The first lever arm 260 comprises at least one third lever arm portion 260.3, which is coupled to the drive unit 290 via a third articulation point 260.31. The first lever arm 260 comprises at least one fourth lever arm portion 260.4, which is articulated to the coupling rod 280 via a fourth articulation point 260.41. The first lever arm 260 is held spring-loaded at the second articulation point 260.21 on the carrier element 24.

The second lever arm 270 comprises at least one first lever arm portion 270.1, which is articulated via a first articulation point 270.11 on the door handle 22, for example on a second handle arm of the door handle 22. The second lever arm 270 comprises at least one second lever arm portion 270.2, which is articulated on the carrier element 24 via a second articulation point 270.21. The second lever arm 270 comprises at least one third lever arm portion 270.3, which is coupled to the coupling rod 280 via a third articulation point 270.31. The coupling rod 280 can be held spring-loaded on the carrier element 24. The coupling rod 280 may be slightly preloaded outwards (on the right side). This preload can be achieved by a compression spring, which ensures a reset movement of the coupling rod 280 to the right.

The door handle 22 can be designed to be electrically movable during normal operation of the door handle arrangement 20. The drive unit 290 is provided for an electrical extension movement and retraction movement of the door handle 22, and cooperates with the adjusting mechanism 26, in particular with the first lever arm 260, and in particular is coupled to it in terms of movement, in order to move and position the door handle 22 from the non-use position 30 into the use position 32, or vice versa, during operation of the drive unit 290.

The movement of the first lever arm 260 initiated by the drive unit 290, for example a pivoting movement or tilting movement, is transmitted to the second lever arm 270 via the coupling rod 280. The movement of the coupling rod 280 causes a movement, for example a pivoting movement or a tilting movement, of the second lever arm 270 to fully extend the door handle 22.

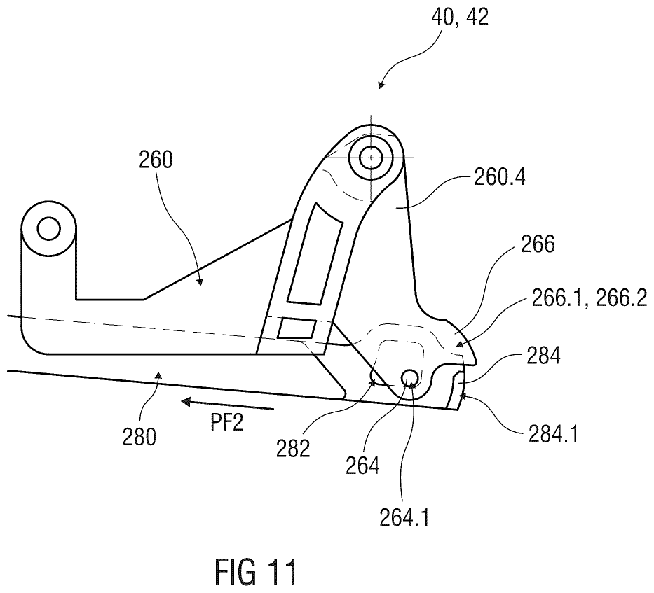

The door handle arrangement 20 may further include an emergency extension function. An emergency extension mechanism 40 (described in more detail in FIGS. 11 to 14) can mechanically, for example manually, move the door handle 22 from the non-use position 30 to the use position 32 when the drive unit 290 is not in operation, for example in the event of a failure of the electronics and/or a motor. The emergency extension mechanism 40 can be designed such that for emergency extension of the door handle 22 the second lever arm 270 can be moved independently of the first lever arm 260 (described in more detail in FIGS. 11 to 14).

The door handle 22 may, for example, have a reinforcement plate 22.1 on its rear side. The reinforcement plate 22.1 can have a recess on both sides for the respective lever arms 260, 270. The carrier element 24 can have a number of door fastenings 24.1 on the edge. The carrier element 24 can be designed as a support plate.

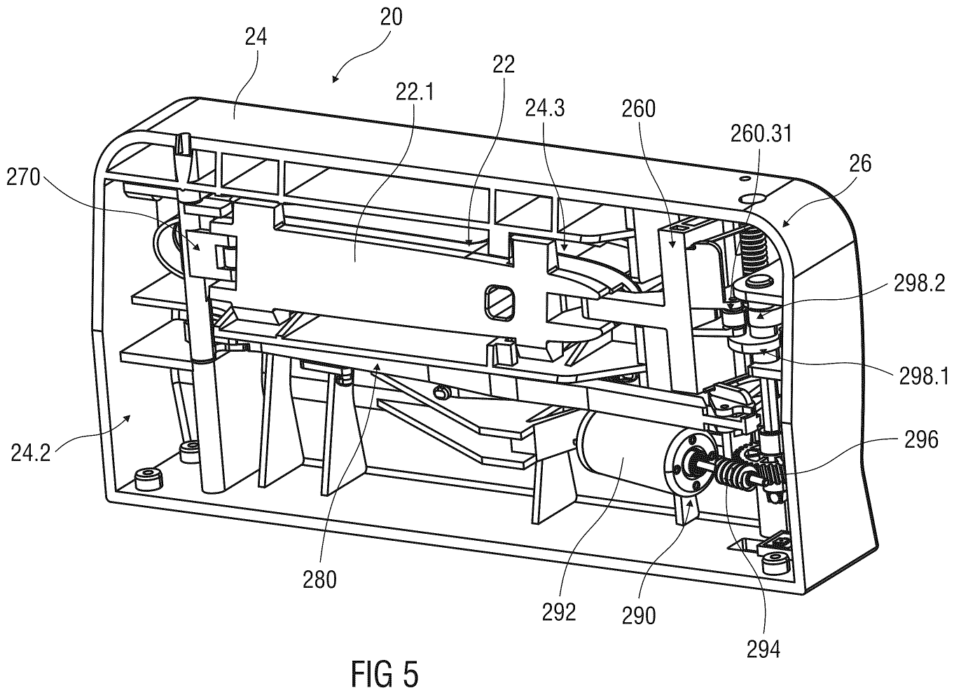

FIG. 5 is a schematic rear view of a further embodiment of a door handle arrangement 20 with a carrier element 24, a door handle 22 and an adjusting mechanism 26.

The adjusting mechanism 26 is designed analogously to the adjusting mechanism 26 of FIG. 4.

The carrier element 24 can be designed in the form of a support shell. The carrier element 24 can have a receiving space 24.2 for arranging and fastening the adjusting mechanism 26 and a handle opening 24.3.

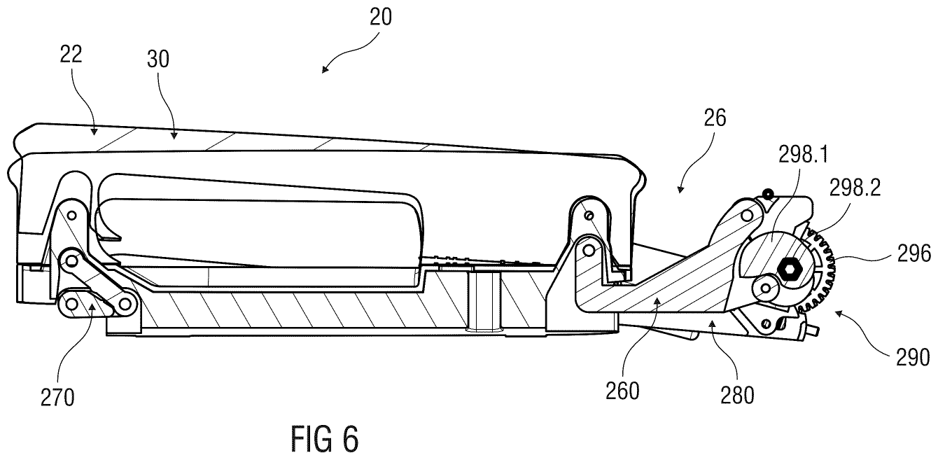

The drive unit 290 comprises at least one motor unit 292, a worm 294 drivable by the motor unit 292, and a gearwheel 296 meshing with the worm 294. A main cam 298.1, shown in more detail in FIGS. 5 and 6, can be moved by driving the gearwheel 296. The main cam 298.1 can be operatively connected to the gearwheel 296 via a cam carrier 298.2. At least one main cam 298.1 for the controlled movement of the door handle 22 can be arranged on the cam carrier 298.2. The cam carrier 298.2 can be designed as a camshaft and have a cam axle. The first lever arm 260 can be operatively connected to the main cam 298.1 of the adjusting mechanism 26. The main cam 298.1 is configured to actuate the lever arm 260. In a further development, the main cam 298.1 can cooperate with the third articulation point 260.31 to actuate the lever arm 260. The main cam 298.1 is designed, for example, as an eccentric or an eccentric unit.

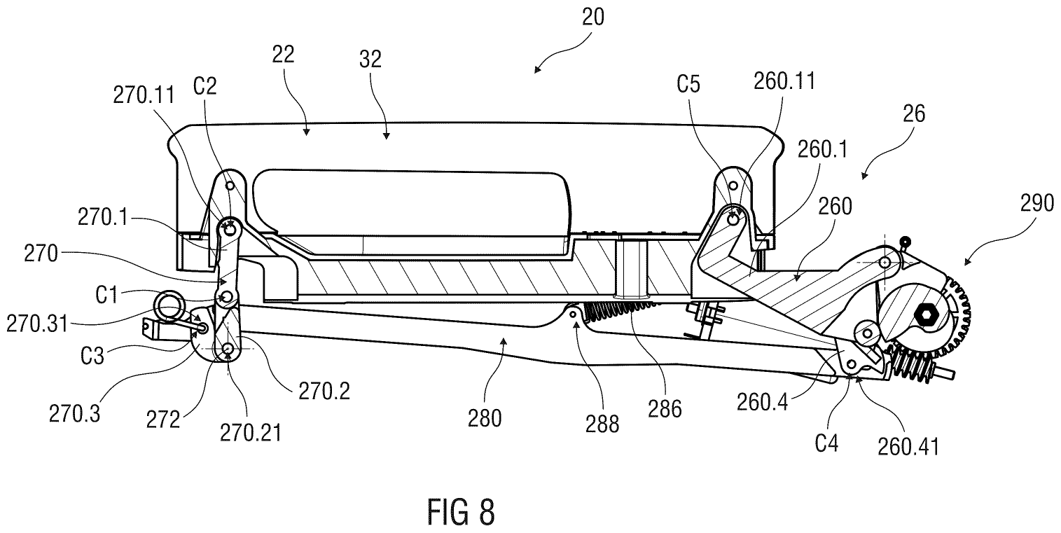

The coupling rod 280 is held preloaded in and/or on the carrier element 24 via a spring element 286 (shown in FIG. 8). For example, the coupling rod 280 may have a spring receptacle 288 (shown in FIG. 8) in which the spring element 286 is fastened at the end. Another end of the spring element 286 is fastened to the carrier element 24. The spring element 286 is arranged substantially obliquely or largely perpendicularly to a longitudinal extension of the coupling rod 280.

FIG. 6 is a schematic plan view of a door handle arrangement 20 with a carrier element 24, a door handle 22 partially moved from a non-use position 30, and an adjusting mechanism 26.

By driving the gearwheel 296, a main cam 298.1 shown in more detail in FIG. 6 can be moved. The main cam 298.1 can be operatively connected to the gearwheel 296 via a cam carrier 298.2. At least one main cam 298.1 for the controlled movement of the door handle 22 can be arranged on the cam carrier 298.2. The cam carrier 298.2 can be designed as a camshaft and have a cam axle. The first lever arm 260 can be connected to a main cam 298.1 of the adjusting mechanism 26, wherein additional drive cams can also be provided which can cooperate with the main cam 298.1 to actuate the lever arm 260. In a further development, the main cam 298.1 can cooperate with the third articulation point 260.31 (shown in FIG. 4, 5) to actuate the lever arm 260.

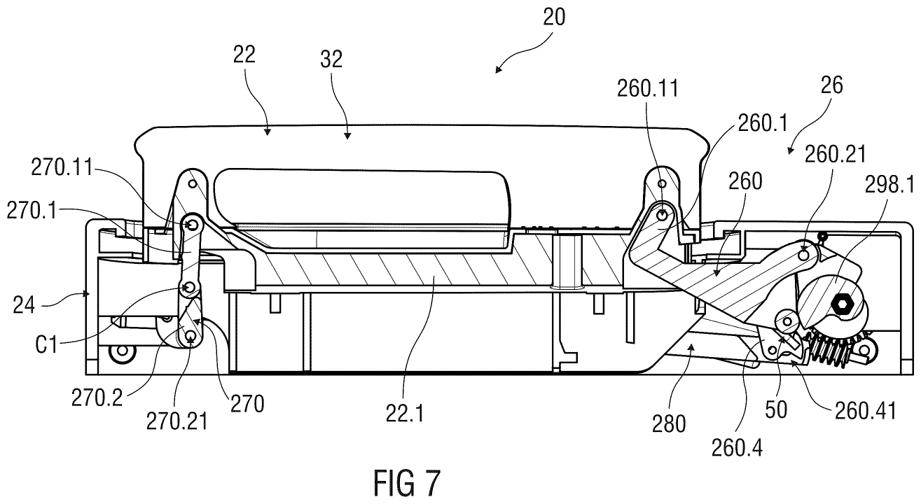

FIG. 7 is a schematic plan view of a door handle arrangement 20 having a door handle 22 in a use position 32.

For example, a counterpart 50 is provided for the main cam 298.1, i.e., the eccentric. The counterpart 50 is connected to the first lever arm 260. The counterpart 50 can be designed as a roller in order to reduce friction losses within the adjusting mechanism 26.

The second lever arm 270 is designed as a toggle lever. The second lever arm 270 comprises a first lever arm portion 270.1, which is articulated at one end to the door handle 22 and at an opposite end in an articulated connection C1 with the second lever arm portion 270.2. The second lever arm portion 270.2 is articulated to the carrier element 24.

FIG. 8 shows a schematic plan view of a door handle arrangement 20 having a door handle 22, in a use position 32.

The second lever arm 270 is designed as a toggle lever. The second lever arm 270 comprises a first lever arm portion 270.1, which is articulated at one end to the door handle 22, for example at the first articulation point 270.11 and via an articulated connection C2. The articulated connection C2, for example, is an articulated connection between the handle and the toggle lever. The second lever arm 270 is articulated at another end in the articulated connection C1 with the second lever arm portion 270.2. The articulated connection C1, for example, is an articulated connection between two toggle lever elements. The second lever arm portion 270.2 is articulated to the carrier element 24 (shown in FIG. 6), for example at the second articulation point 270.21. The second lever arm portion 270.2 has a third lever arm portion 270.3 which is articulated to the coupling rod 280, for example via an articulated connection C3 and in the third articulation point 270.31.

The first lever arm 260 is articulated to the coupling rod 280 at the fourth articulation point 260.41. In particular, the coupling rod 280 is articulated to the first lever arm 260 in the articulated connection C4. The first lever arm 260 is further articulated to the door handle 22, for example at the first articulation point 260.11 and via an articulated connection C5.

The door handle 22, the first lever arm 260 (pivot lever or extending lever), the second lever arm 270 (toggle lever) and the coupling rod 280 (push rod) form a functional pentagon.

The first, in particular right, lever arm 260 is driven by the drive unit 290.

When it extends, the coupling rod 280 presses to the left, and thus the second, in particular left lever arm 270 is also moved, in particular rotated. The movement of the right lever arm 260 also results in the movement of the left lever arm 270. This effect does not apply in the opposite situation, since the left lever arm 270 can extend without entraining the right lever arm 260. This condition allows the door handle 22 to be extended manually, for example in an emergency situation.

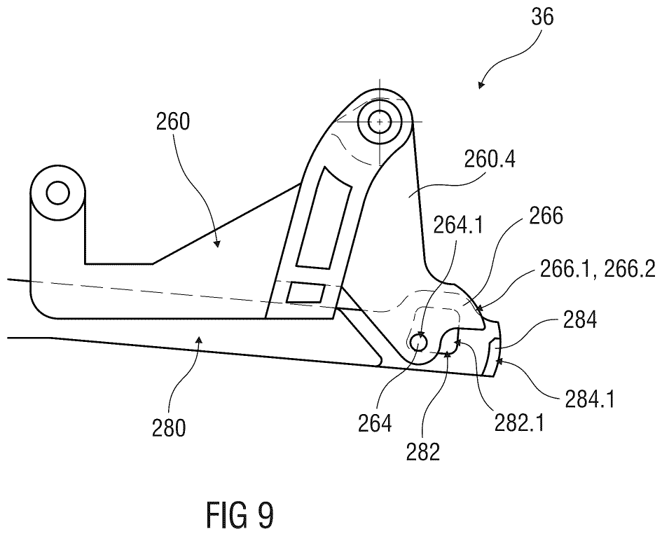

FIG. 9 is a schematic detail of a door handle arrangement 20 with an adjusting mechanism 26 in an initial position 36 in which the lever arms 260, 270 are retracted. When the first, in particular right lever arm 260 begins to extend, the coupling rod 280 is pressed to the left, such that the second, in particular left lever arm 270 is entrained, in particular rotated, by its coupling with the coupling rod 280.

The coupling rod 280 comprises at least one guide element 282.1 and one stop element 284.1. The guide element 282.1 is, for example, a guide opening, in particular a hole contour 282. The guide element 282.1 is further described below as the hole contour 282. The stop element 284.1 is, for example, a support edge 284 and will be further described as such below.

The coupling rod 280 comprises a hole contour 282 and a support edge 284 in the region of the coupling and/or the linkage with the first lever arm 260.

The first lever arm 260 comprises at least one counter guide element 264 and one counter stop element 266.1. The counter guide element 264 is, for example, a guide pin 264.1. The counter stop element 266.1 is, for example, a counter stop lug 266.2 or a counter stop projection. In the following, the counter stop element 266.1 is also referred to as contact element 266.

The coupling rod 280 is provided with a hole contour 282 and a support edge 284 for the controlled movement of the door handle 22. The hole contour 282 cooperates with a counter guide element 264 arranged on the first lever arm 260 to move the door handle 22 from the non-use position 30 into the use position 32. The first lever arm 260 comprises, for example, a counter guide element 264 designed as a guide pin 264.1 or guide bolt, which is held and guided in the hole contour 282. When the first lever arm 260 is driven, the counter guide element 264 is moved in such a way that it comes into contact and/or engagement with the hole contour 282 in order to move the coupling rod 280 (here: to the left).

The support edge 284 of the coupling rod 280 cooperates with a contact element 266 arranged on the first lever arm 260 to move the door handle 22 from the use position 32 into the non-use position 30. The contact element 266 can, for example, be a counter edge. The contact element 266 can be designed, for example, as a lug projecting in the longitudinal extension of the door handle 22, or as an extension at the end face. When the first lever arm 260 is driven to return the door handle 22 from the use position 32 to the non-use position 30, the contact element 266 comes into contact with and/or engagement with the support edge 284, so that the coupling rod 280 is moved (here: to the right).

The first, in particular right, lever arm 260 is driven by the drive unit 290. When it extends, the coupling rod 280 presses to the left, and thus the second, in particular left lever arm 270 is also moved, in particular rotated. The movement of the right lever arm 260 also results in the movement of the left lever arm 270. This effect does not apply in the opposite situation, since the left lever arm 270 can extend without entraining the right lever arm 260, due to the hole contour 282. This condition enables the mechanical, in particular manual, extension of the door handle 22, for example in an emergency situation.

The hole contour 282 can be substantially oval, square or polygonal. The hole contour 282 can be designed, for example, as an oval without any axes of symmetry.

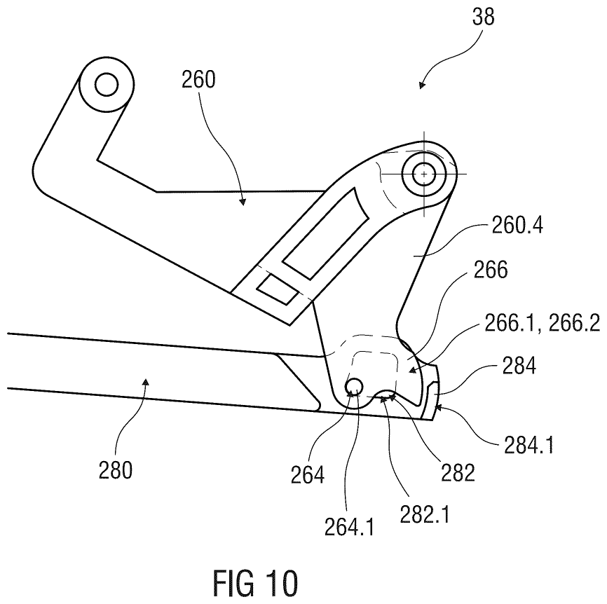

FIG. 10 is a schematic detail of a door handle arrangement 20 with an adjusting mechanism 26 (shown in FIG. 6) in an extended position 38. The right and left lever arms 260, 270 (shown in FIG. 6) are extended. Due to a relative movement between the right lever arm 260 and the coupling rod 280, the contact element 266 of the right lever arm 260 moves just in front of the support edge 284 of the coupling rod 280. The hole contour 282 in the coupling rod 280 is not actuated, at least initially, and is thus “deactivated.” The contact between the contact element 266 and the support edge 284 allows a controlled retraction of the lever arms 260, 270. When the right lever arm 260 retracts and/or is retracted by means of the drive unit 290, the coupling rod 280 is pressed to the right by the contact with the contact element 266. This allows the retraction of the left lever arm 270 to be carried out comparatively securely (with positive control).

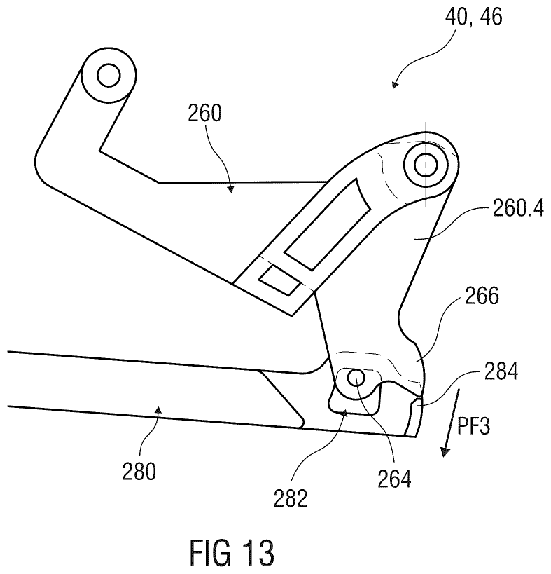

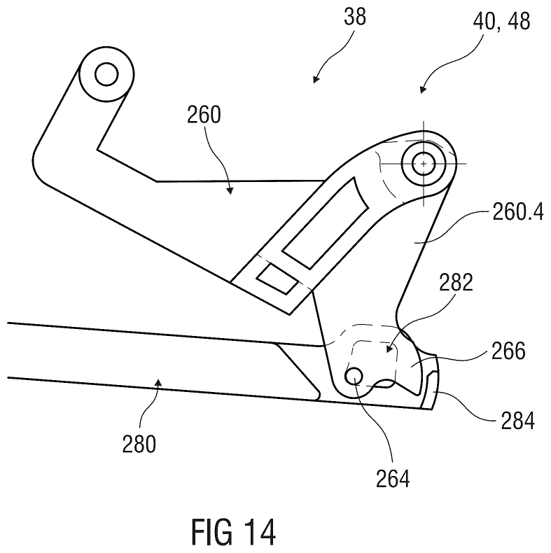

FIG. 11 is a schematic detail of a door handle arrangement 20 with an adjusting mechanism 26 (shown in FIG. 6) in a first emergency extension position 42. The right lever arm 260 is retracted. In the basic state, the coupling rod 280 is held preloaded, in particular pulled, more towards “outwards” or more to the top right. The left lever arm 270 (shown in FIG. 6) is partially extended, for example manually moved, in particular pulled or pressed, by a backup mechanism. The coupling rod 280 is pulled to the left by the extension movement of the left lever arm 270 according to arrow PF2. Due to the shape of the hole contour 282, the movement of the coupling rod 280 is not impaired by the counter guide element 264 of the right lever arm 260 striking the hole contour 282. The coupling rod 280 can be pulled slightly “upwards” so that the counter guide element 264 slides primarily over an inner edge, in particular a lower inner edge of the hole contour 282. The coupling rod 280 can thereby jump from the position according to FIG. 13 to the position according to FIG. 14. The coupling rod 280 can be moved to the left until a rear hole edge of the hole contour 282 comes into contact with the counter guide element 264.

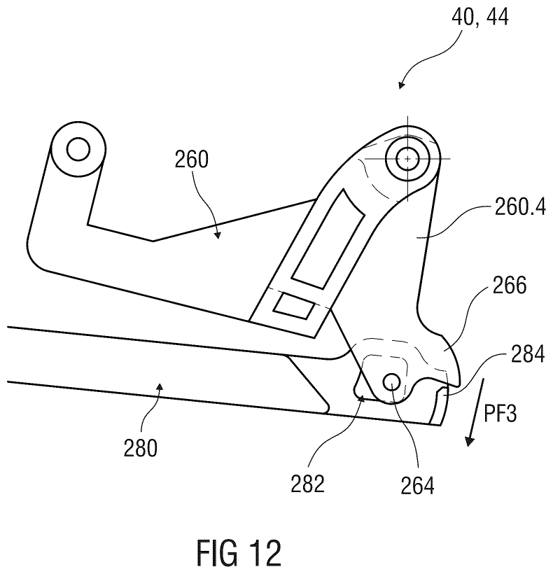

FIG. 12 is a schematic detail of a door handle arrangement 20 with an adjusting mechanism 26 (shown in FIG. 6) in a second emergency extension position 44 (emergency intermediate position). The left lever arm 270 (shown in FIG. 6) remains extended. The right lever arm 260 is slowly pulled outwards mechanically, in particular manually. The contact element 266 of the right lever arm 260 comes into contact with the support edge 284 of the coupling rod 280 and presses the coupling rod 280 downwards according to arrow PF3. Due to the shape of the hole contour 282, the movement of the coupling rod 280 is not impaired by the counter guide element 264 of the right lever arm 260 striking the hole contour 282.

FIG. 13 is a schematic detail of a door handle arrangement 20 with an adjusting mechanism 26 (shown in FIG. 6) in a third emergency extension position 46 (emergency intermediate position). The left lever arm 270 (shown in FIG. 6) remains extended. The right lever arm 260 is further pulled outwards manually. The contact element 266 of the right lever arm 260 remains in contact with the support edge 284 of the coupling rod 280 and thus presses the coupling rod 280 further downwards according to arrow PF3, wherein the counter guide element 264 slides in the hole contour 282 along an upper hole edge.

FIG. 14 is a schematic detail of a door handle arrangement 20 with an adjusting mechanism 26 (shown in FIG. 6) in a fourth emergency extension position 48, which corresponds to a normal extended position 38. The left lever arm 270 (shown in FIG. 6) remains extended. The right lever arm 260 has been manually pulled completely outwards. The contact element 266 of the right lever arm 260 was able to move past the support edge 284 of the coupling rod 280 in such a way that a position of the contact element 266 in the fourth emergency extension position 48 corresponds to the normal extended position 38. The position of the counter guide element 264 now also corresponds to the extended position 38.

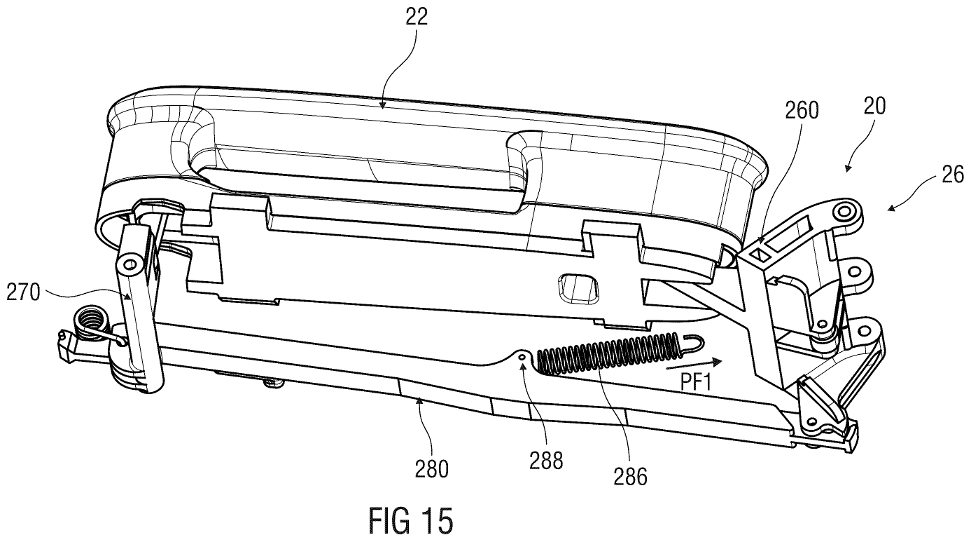

FIG. 15 is a schematic perspective view of a door handle arrangement 20. The coupling rod 280 comprises a spring receptacle 288. The spring receptacle 288 can be designed as a passage. A spring element 286 is provided which preloads the coupling rod 280 “outwards” according to the arrow PF1. This preload direction can be realized, for example, in a simple manner by placing or positioning the spring element 286 substantially obliquely to the longitudinal extension of the coupling rod 280. The spring element 286 is fastened with one end in the spring receptacle 288. With the other end, which is passed through the spring receptacle 288, it is fastened in and/or on the carrier element 24. The coupling rod 280 is pulled outwards by the spring element 286. The spring element 286 can be a compression spring, for example. When the right lever arm 260 and/or the left lever arm 270 are extended, the coupling rod 280 is moved against the spring force or preload force of the spring element 286—in this case, moved to the left. The spring element 286 is designed to ensure a reset movement of the coupling rod 280, for example when the door handle 22 is retracted.

### LIST OF REFERENCE SIGNS

10 Vehicle door
20 Door handle arrangement
22 Door handle
22.1 Reinforcement plate
24 Carrier element
24.1 Door fastening
24.2 Receiving space
24.3 Handle opening
26 Adjusting mechanism
260 First lever arm
260.1 to 260.4 Lever arm portion
260.11 to 260.41 Articulation point
262 First axle
264 Counter guide element
264.1 Guide pin
266 Contact element
266.1 Counter stop element
266.2 Counter stop lug
270 Second lever arm
270.1 to 270.3 Lever arm portion
270.11 to 270.31 Articulation point
272 Second axle
280 Coupling rod
282 Hole contour
282.1 Guide element
284 Support edge
284.1 Stop element
286 Spring element
288 Spring receptacle
290 Drive unit
292 Motor unit
294 Worm
296 Gearwheel
298.1 Main cam
298.2 Cam carrier
30 Non-use position
32 Use position
34 End position
36 Initial position
38 Extended position
40 Emergency extension mechanism
42 First emergency extension position
44 Second emergency extension position
46 Third emergency extension position
48 Fourth emergency extension position
50 Counterpart
C1 to C5 Articulated connection
PF1 to PF3 Arrow

What is claimed is:

1. An outside door handle arrangement for a vehicle door, comprising at least one movable door handle and an adjusting mechanism for the controlled movement of the door handle, wherein the adjusting mechanism comprises at least one first lever arm and a coupling rod with at least one guide element and one stop element,
wherein the first lever arm
cooperates with the guide element of the coupling rod to move the door handle from a non-use position into a use position, and
cooperates with the stop element to move the door handle from the use position into the non-use position.

2. The door handle arrangement according to claim 1, wherein the guide element of the coupling rod is designed as a guide opening comprising a hole contour, and the stop element is designed as a stop edge comprising a support edge.

3. The door handle arrangement according to claim 1, wherein the guide element is arranged in the region of a rod end of the coupling rod and the stop element is arranged on the rod end of the coupling rod.

4. The door handle arrangement according to claim 1, wherein the first lever arm comprises at least one counter guide element which is guided in or on the guide element of the coupling rod.

5. The door handle arrangement according to claim 1, wherein the first lever arm comprises at least one counter stop element which comes into contact with the stop element of the coupling rod in order to return the door handle from the use position to the non-use position.

6. The door handle arrangement according to claim 4, wherein, in the non-use position, the counter guide element of the first lever arm is positioned in a front region of the guide element of the coupling rod and the counter stop element of the first lever arm is positioned pivoted away relative to the stop element of the coupling rod.

7. The door handle arrangement according to claim 4, wherein, in the use position, the counter guide element of the first lever arm is in contact with the front region of the guide element of the coupling rod and the counter stop element of the first lever arm is pivoted towards the stop element of the coupling rod and is positioned in front of it.

8. The door handle arrangement according to claim 1, wherein, in normal operation, a movement of the first lever arm causes a movement of the coupling rod, so as to extend or retract a second lever arm coupled to the coupling rod.

9. The door handle arrangement according to claim 8, wherein, in emergency operation, the second lever arm and the coupling rod are initially manually movable independently of the first lever arm until an emergency intermediate position is reached.

10. The door handle arrangement according to claim 9, wherein, in the emergency intermediate position, the counter guide element of the first lever arm is positioned in a rear region of the guide element of the coupling rod and the counter stop element of the first lever arm comes into contact or is in contact with the stop element of the coupling rod.

11. The door handle arrangement according to claim 10, wherein, in the emergency intermediate position, a further movement of the coupling rod causes an extension of the first lever arm, wherein the counter stop element of the first lever arm presses the coupling rod downwards on its stop element and pivots past the same until the use position is reached.

12. A vehicle door having at least one door handle arrangement according to claim 1.
